(19) United States
(12) Patent Application Publication
(10) Pub. No.: US 2008/0042931 A1
(43) Pub. Date: Feb. 21, 2008

(54) PLASMA DISPLAY PANEL WITH HIGH BRIGHTNESS

(76) Inventors: Hsu-Pin KAO, Pingjhen City (TW); Jang-Jeng Liang, Taoyuan City (TW); Sheng-Wen Hsu, Taipei City (TW); Hsu-Chia Kao, Pingjhen City (TW); Tsan-Hung Tsai, Sanchong City (TW)

Correspondence Address: BIRCH STEWART KOLASCH & BIRCH, PO BOX 747, FALLS CHURCH, VA, 22040-0747, US

(21) Appl. No.: 11/840,066

(22) Filed: Aug. 16, 2007

(30) Foreign Application Priority Data
Aug. 18, 2006 (TW) 095130549

(51) Int. Cl. G09G 3/28

(52) U.S. Cl. 345/60

(57) ABSTRACT

A plasma display panel is provided. The plasma display panel includes N scan electrodes, N auxiliary electrodes, M address electrodes, and N rows and M columns of lighting cells. The ith row of lighting cells among the N rows of lighting cells corresponds to the ith scan electrode among the N scan electrodes and the ith auxiliary electrode among the N auxiliary electrodes. The jth lighting cell in the ith row of lighting cells corresponds to the jth address electrode among the M address electrodes. When the jth lighting cell in the ith row of lighting cells is assigned to be lightened, the ith scan electrode, the ith auxiliary electrode, and the jth address electrode are operated to generate discharge effects in the jth lighting cell in the ith row of lighting cells.

### BACKGROUND OF THE INVENTION

1. Field of the Invention

The invention relates to a display apparatus and, more specifically, to a plasma display apparatus.

2. Description of the Prior Art

A plasma display panel (PDP) has many advantages such as high lightness, high efficiency, high contrast, high writing speed, and low cost. Thus, it is one of the current mainstream technologies of large-sized digital flat display panels.

As shown in FIG. 1A, a conventional plasma display panel 10 includes three main parts: a front plate 12, a back plate 14, and a shadow mask 16 between the front plate 12 and the back plate 14.

In general, the front plate 12 includes a first glass substrate 121, a plurality of scan electrodes 122, a transparent dielectric layer 124, and a first protective layer 125. The back plate 14 includes a second glass substrate 141, a plurality of address electrodes 142, a dielectric layer 143, and a second protective layer 144. The shadow mask 16 includes a plurality of barrier ribs 161 and a plurality of color phosphors 162. In this example, the marks 162A, 162B, and 162C represent red, green, and blue phosphors respectively.

Each of the independent spaces containing the color phosphors 162 among the barrier ribs 161 can be seen as a lighting cell. These lighting cells are filled with a mixture of noble gases such as He, Ne, Xe, etc. By controlling the scan electrode 122 and the address electrode 142, the control circuit (not shown in the figure) of the plasma display panel 10 can decide whether the lighting cells radiate and what their radiation strength is. When the scan electrode 122 and the address electrode 142 corresponding to a certain lighting cell generate high voltage electricity, the gas of that lighting cell will be triggered to discharge and radiate ultraviolet rays. These ultraviolet rays will further excite the color phosphors 162 in the lighting cell to generate visible lights of red, green, and blue.

The transparent dielectric layer 124 and the dielectric layer 143 are also called dielectric layers. They can store charges and achieve memory effect to keep images. The function of the first protective layer 125 and the second protective layer 144 is to prevent wearing out of the electrodes.

FIG. 1B is a schematic diagram of the shadow mask 16, the scan electrodes 122, and the address electrodes 142 viewed along the direction 18A. As shown in FIG. 1B, the scan electrode 122 is perpendicular to the address electrode 142; each of the lighting cells are arranged in order on the same plane with the barrier ribs 161 as their frame.

In practical applications, when certain lighting cell is assigned to be lightened, the scan electrode 122 and the address electrode 142 corresponding to the lighting cell will form wall charges within the lighting cell during an address period. Afterward, the scan electrode 122 and the address electrode 142 will provide appropriate voltage to make the gas in the lighting cell generate discharge phenomenon during a sustain period. Referring to FIG. 1C, FIG. 1C shows an example of voltage provided to the scan electrode 122 in the sustain period. In general, the voltage provided to the scan electrode 122 includes an alternating voltage, and the voltage provided to the address electrode 142 is a direct voltage.

Referring to FIG. 2, FIG. 2 is a schematic diagram of opposite discharge between the scan electrode 122 and the address electrode 142 corresponding to a certain lighting cell. In the prior art, the discharge distance between the scan electrode 122 and the address electrode 142 is about equal to the distance between the front plate 12 and the back plate 14, and the distance also equals to the thickness of the shadow mask 16 (generally 90˜150 μm).

As those skilled in the art know, the discharge distance is in direct proportion to the discharge efficiency and the lightness of the lighting cell. That is to say, the lightness can be improved by increasing the discharge distance. However, it is not easy to produce a shadow mask of high thickness, and the cost is also high. Besides, the thickness of the shadow mask 16 is also in direct proportion to the firing voltage between the scan electrode 122 and the address electrode 142. Although the lightness can be improved by increasing the thickness of the shadow mask, a high firing voltage is unfavorable to surrounding driving circuits. Thus, increasing the thickness of the shadow mask is not a good solution to improve lightness.

Furthermore, traditional manufacturing procedures of large-sized plasma display panels can not ensure that the planes of the front plate 12, the back plate 14, and the shadow mask 16 opposite to each other will be absolutely smooth. This causes some differences in the discharge distance among various parts of the same plasma display panel. Moreover, the different discharge distances will result in the difference of the electric driving characteristic among the areas of the plasma display panel. Therefore, the image quality on the plasma display panel will be debased.

Beside the above problems of lightness and smoothness, another drawback of the prior art is that only one discharge area exists in each of the lighting cells. As shown in FIG. 1B, each of the lighting cells in the prior art is in a rectangular form. Because the electric field generated by the scan electrode 122 and the address electrode 142 is concentrated in the central part of the lighting cell, the color phosphors laid on other parts of the lighting cell are not fully utilized. Thus, the central part of the lighting cell will wear out faster and have shorter lifespan than other parts of the lighting cell.

### SUMMARY OF THE INVENTION

In order to solve the above problems, the invention provides a novel structure of plasma display panel.

According to the invention, a preferred embodiment is a plasma display panel including a front plate, a back plate, and N rows and M columns of lighting cells. N and M are both positive integers. The front plate includes N scan electrodes and N auxiliary electrodes. The back plate includes M address electrodes. The ith row of lighting cells among the N rows of lighting cells corresponds to the ith scan electrode among the N scan electrodes and the ith auxiliary electrode among the N auxiliary electrodes, wherein i is an integer index ranging from 1 to N. The jth lighting cell in the ith row of lighting cells corresponds to the jth address electrode among the M address electrodes, wherein j is an integer index ranging from 1 to M. When the jth lighting cell in the ith row of lighting cells is assigned to be lit up, the ith scan electrode, the ith auxiliary electrode, and the jth address electrode are operated to generate discharge effects in the jth lighting cell in the ith row of lighting cells.

The advantage and spirit of the invention may be understood by the following recitations together with the appended drawings.

### BRIEF DESCRIPTION OF THE APPENDED DRAWINGS

FIG. 1A and FIG. 1B show the structure of a conventional plasma display panel; FIG. 1C shows an example of voltage provided to the scan electrode in the sustain period.

FIG. 2 is a schematic diagram of opposite discharge in a certain lighting cell in the prior art.

FIG. 3 is a schematic diagram of a plasma display panel according to a preferred embodiment of the invention.

FIG. 4 shows an example of voltage provided to the scan electrode in the sustain period.

FIG. 5 is a schematic diagram of opposite discharge in certain lighting cell in the invention

FIG. 6 shows the scan voltages corresponding to two adjacent rows of lighting cells.

FIG. 7 shows the respective current directions of two adjacent rows of lighting cells when the electrodes discharge after providing the above scan voltages.

FIG. 8 shows the scan electrode and auxiliary electrode after their shapes are changed.

FIG. 9A shows the shadow mask of another preferred embodiment according to the invention; FIG. 9B and FIG. 9C show the configure mode of the scan electrode and the auxiliary electrode.

FIG. 10 is a schematic diagram of the plasma display panel including 2*N scan electrodes in the preferred embodiment.

FIG. 11 shows the scan voltages corresponding to two adjacent rows of lighting cells.

### DETAILED DESCRIPTION OF THE INVENTION

The invention provides a plasma display panel with high lightness, long lifetime, and high yield of manufacturing process.

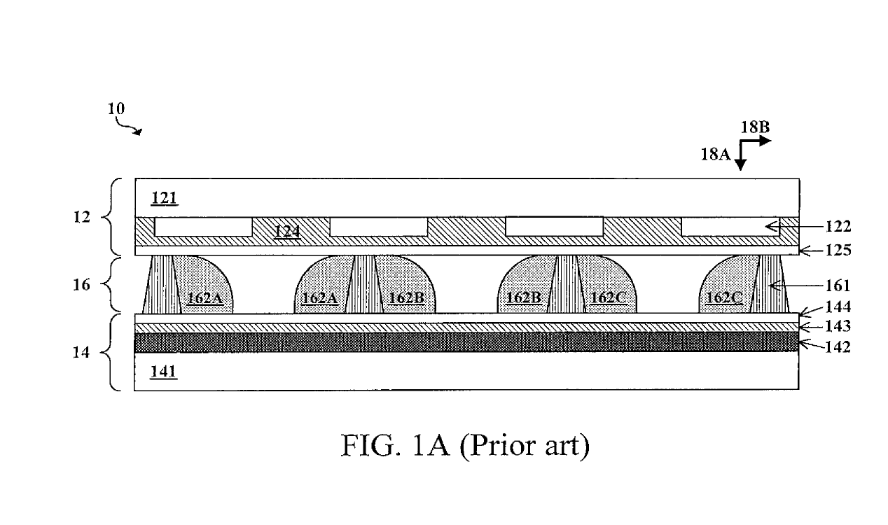

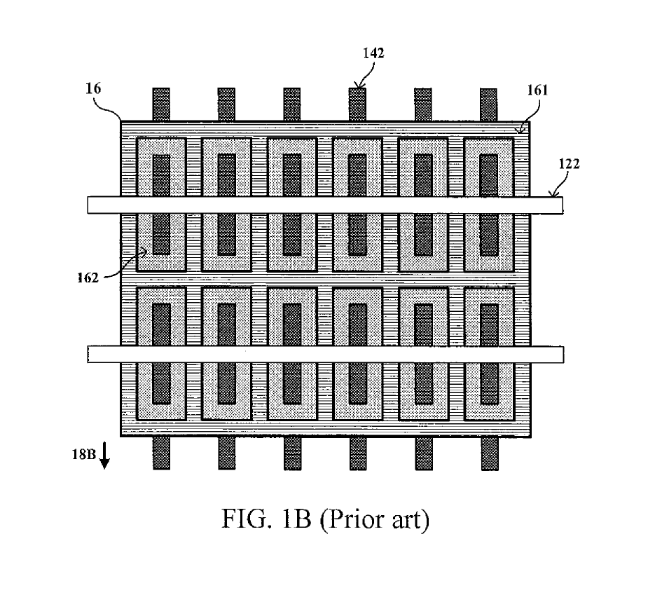

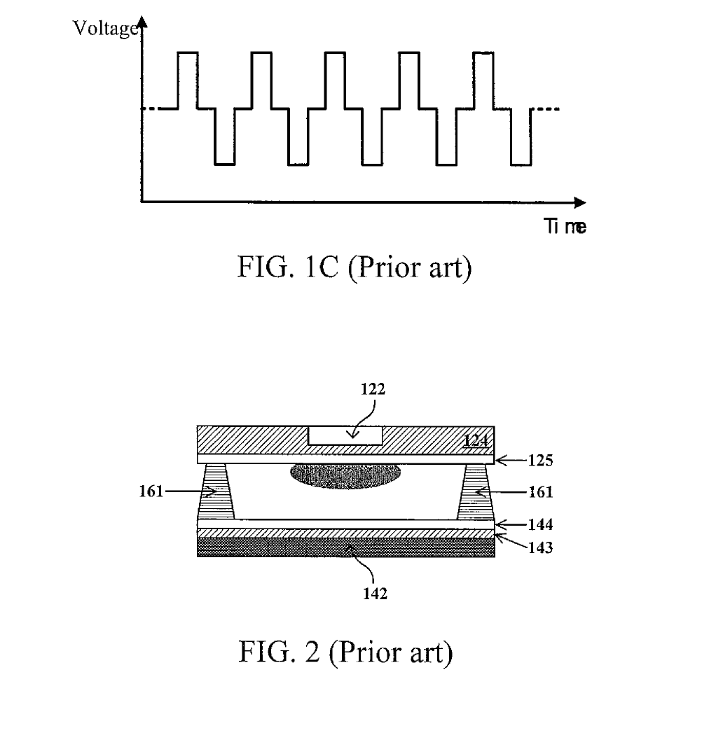

According to the invention, a preferred embodiment is a plasma display panel including a front plate, a back plate, and N rows and M columns of lighting cells. N and M are both positive integers. In practical applications, as shown in FIG. 1A and FIG. 1B, the lighting cells are a plurality of spaces separated by a shadow mask located between the front plate and the back plate; the shadow mask can include a plurality of barrier ribs and a plurality of color phosphors.

In the embodiment according to the invention, the front plate includes N scan electrodes and N auxiliary electrodes. The back plate includes M address electrodes. The ith row of lighting cells among the N rows of lighting cells corresponds to the ith scan electrode among the N scan electrodes and the ith auxiliary electrode among the N auxiliary electrodes, wherein i is an integer index ranging from 1 to N. Moreover, the jth lighting cell in the ith row of lighting cells corresponds to the jth address electrode among the M address electrodes, wherein j is an integer index ranging from 1 to M. In other words, each row of lighting cells corresponds to a scan electrode and an auxiliary electrode; each column of lighting cells corresponds to an address electrode.

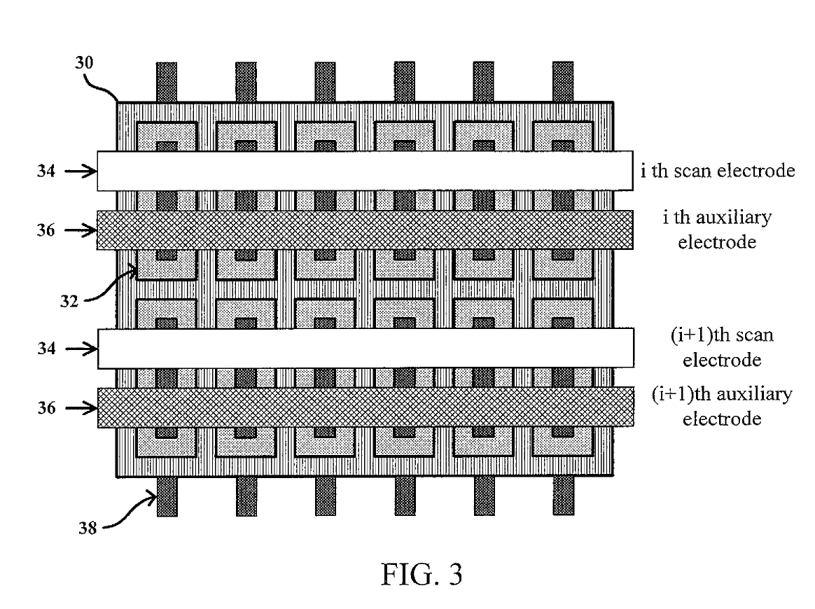

Referring to FIG. 3, FIG. 3 is a schematic diagram of the preferred embodiment. In order to make the schematic diagram clearer, the front plate and the back plate are not shown in the diagram. Mark 30 represents the shadow mask located between the front plate and the back plate. Mark 32 represents the lighting cells. Marks 34, 36, and 38 represent a scan electrode, an auxiliary electrode, and an address electrode respectively.

According to the invention, when certain lighting cell 32 is assigned to be lightened, the scan electrode 34, auxiliary electrode 36, and address electrode 38 corresponding to the lighting cell 32 are operated to generate discharge effects in the lighting cell 32.

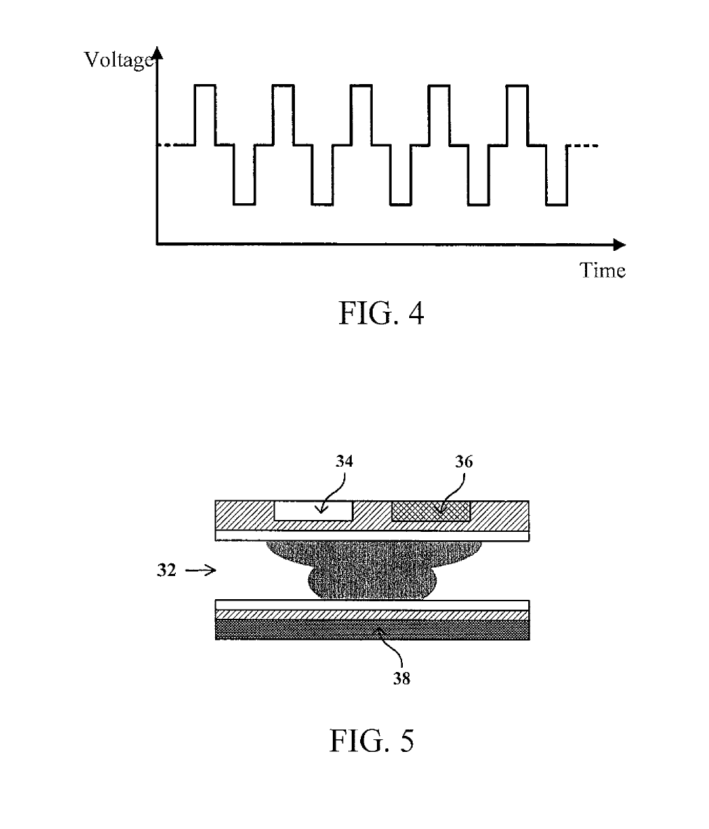

In practical applications, during a first sustain period for lightening the jth lighting cell in the ith row of lighting cells 32, an ith scan voltage is applied to the ith scan electrode 34; an ith auxiliary voltage is applied to the ith auxiliary electrode 36, and a jth address voltage is applied to the jth address electrode 38. As shown in FIG. 4, the ith scan voltage includes a first AC voltage. The ith auxiliary voltage and the jth address voltage are substantially DC voltages. In practical applications, if each of the auxiliary voltages is designed to have the same value, the N auxiliary electrodes 36 can be connected with each other.

Referring to FIG. 5, FIG. 5 shows the discharge condition according to the lighting cell 32 in the invention. The discharge phenomenon is generated not only between the scan electrode 34 and the address electrode 38, but also between the scan electrode 34 and the auxiliary electrode 36. Due to the effect of the address electrode 38, the discharge between the scan electrode 34 and the auxiliary electrode 36 can be far away from the front plate and can move toward the direction of the address electrode 38. This increases the discharge area within the lighting cell 32. Compared to those in the prior art in which each of the lighting cells has only one discharge area concentrated in the central part, the discharge distance in this invention is longer, and the lighting efficiency is higher in the lighting cell 32. The color phosphors spread on the upside and the downside of the lighting cell 32 can also be fully utilized. By enlarging the discharge area within the lighting cell 32, this invention can even prevent the problem of wearing out the central parts of the lighting cell 32 too fast in prior art.

Besides, according to the invention, the discharge gap that dominates the driving characteristics of the lighting cell 32 is related to the distance between the scan electrode 34 and the auxiliary electrode 36 instead of the thickness of the shadow mask 30. Because the distance between the scan electrode 34 and the auxiliary electrode 36 can be easily controlled in the manufacturing process, the plasma display panel, according to the invention, can prevent the problem of varying driving characteristics in the prior art.

Another advantage of the invention is that the effect of the thickness of the shadow mask 30 to the firing voltage is substantially reduced. This is because the discharge gap that dominates the driving characteristics is related to the distance between the scan electrode 34 and the auxiliary electrode 36. Thus, increasing the thickness of the shadow mask to improve the lightness is not harmful to the surrounding driving circuits.

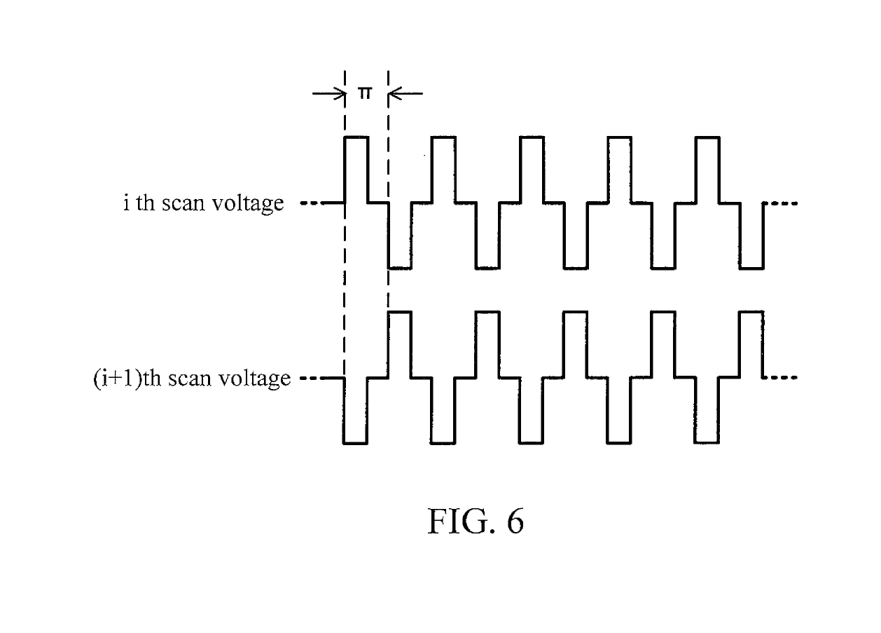

In practical applications, the plasma display panel, according to the invention, can further control the scan voltage provided to the scan electrode 34 to reduce electromagnetic interference. Referring to FIG. 6, FIG. 6 shows the scan voltages corresponding to two adjacent rows of lighting cells 32. During a second sustain period for lightening the jth lighting cell in the (i+1)th row of lighting cells 32, an (i+1)th scan voltage is applied to the (i+1)th scan electrode among the N scan electrodes 34. The (i+1)th scan voltage includes a second AC voltage. The amplitudes of the first AC voltage and the second AC voltage are substantially the same, and the first AC voltage and the second AC voltage are substantially out of phase. That is to say, during the sustain period, the amplitudes of the scan voltages corresponding to two adjacent rows of lighting cells 32 are the same, and the phase difference is about 180°.

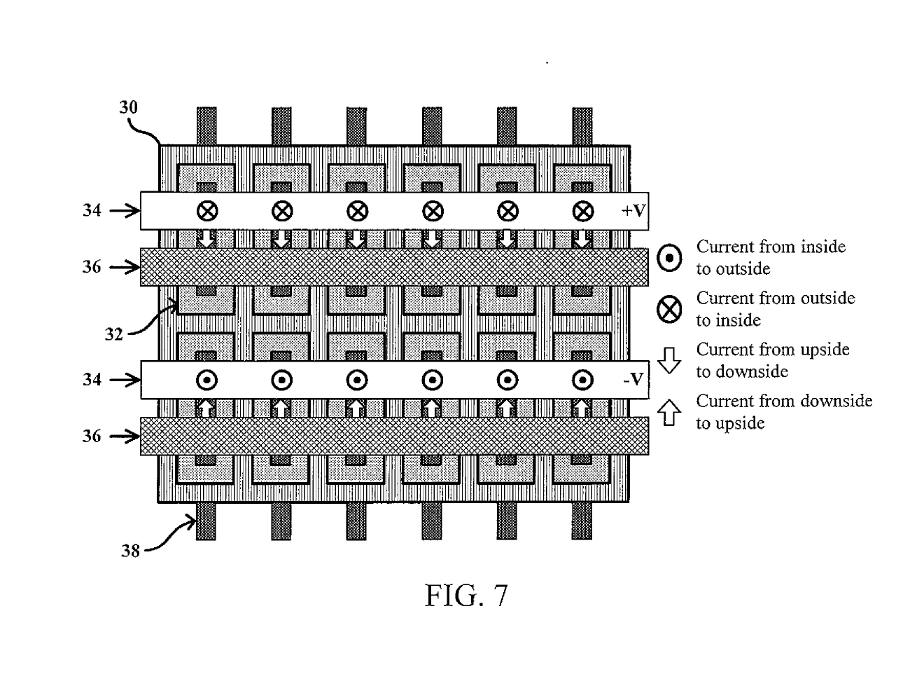

FIG. 7 shows the respective current directions of two adjacent rows of lighting cells 32 when the electrodes discharge after providing the above scan voltages. As shown in FIG. 7, because the scan voltages of two adjacent rows of lighting cells 32 are out of phase, the current directions of two adjacent rows of lighting cells 32 are also opposite. In this way, the electromagnetic interference generated by two adjacent rows of lighting cells 32 will be cancelled out. Besides, the opposite current directions can reduce 50% of peak current for the entire circuit. This not only reduces the cost but also increases the lifetime of the plasma display panel. Moreover, this embodiment can also effectively suppress noise problems due to the opposite vibrating direction generated during the discharge of the noble gases.

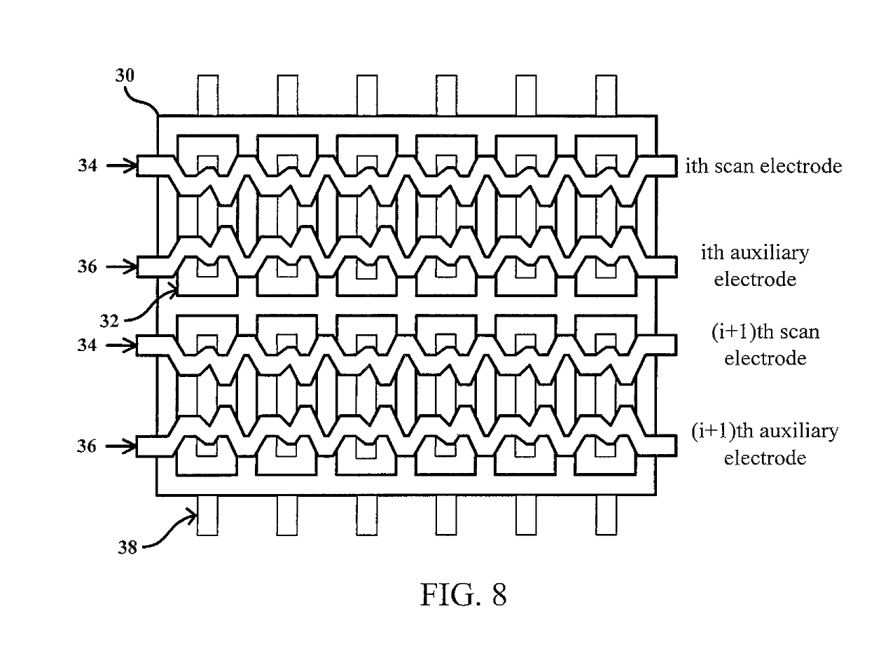

In practical applications, the plasma display panel, according to the invention, can also change the shape of the scan electrode 34 and the auxiliary electrode 36 to further improve the lighting efficiency. FIG. 8 shows the scan electrode 34 and auxiliary electrode 36 after their shapes are changed. As shown in FIG. 8, each of the lighting cells 32 includes a first lighting region and a second lighting region respectively. The distances between the scan electrode 34 and the auxiliary electrode 36 corresponding to the first lighting regions are larger than those corresponding to the second lighting regions. That is to say, the discharge gap of the first lighting region is larger than that of the second lighting region in each of the lighting cells 32.

The advantage of this embodiment is that the parts with smaller discharge gap can provide lower firing voltage while the parts with larger discharge gap can generate higher lightness. The lower firing voltage area will generate discharge phenomenon earlier; on the contrary, in the higher firing voltage area, the generation time of discharge phenomenon will be later. By doing so, this embodiment can lower the discharge peak current to reduce the load of the circuit system. Besides, the electrode shape shown in FIG. 8 can disperse the current to enlarge the discharge area. This not only can increase the lifetime of the panel but also improve the lighting efficiency.

In practical applications, the front plate of the above mentioned plasma display panel can further include a first glass substrate, a transparent dielectric layer, and a first protective layer. The back plate of the plasma display panel can further include a second glass substrate, a dielectric layer, and a second protective layer.

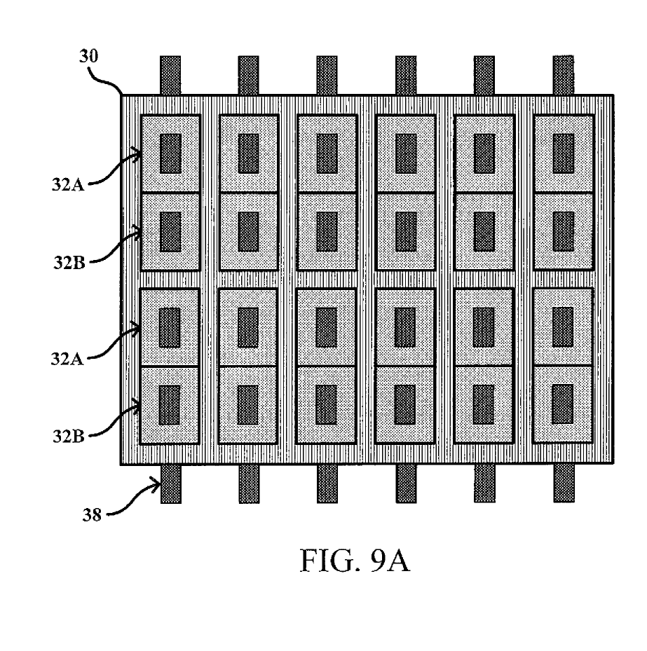

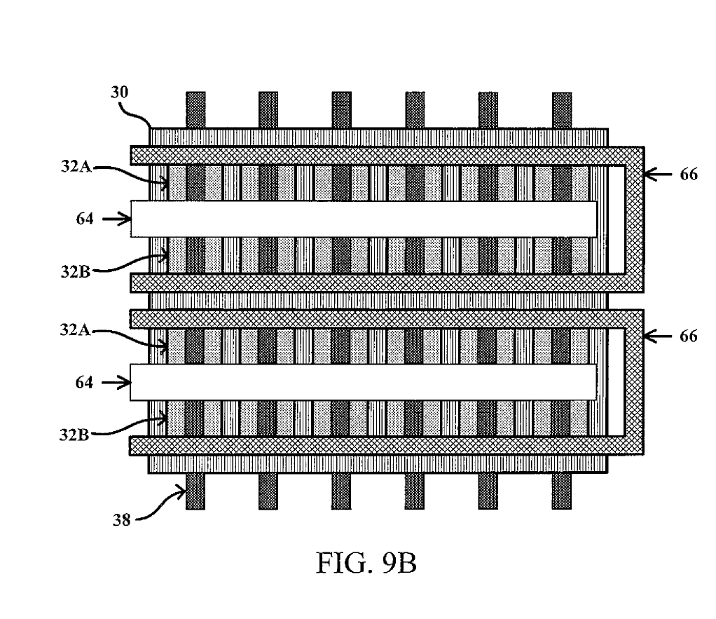

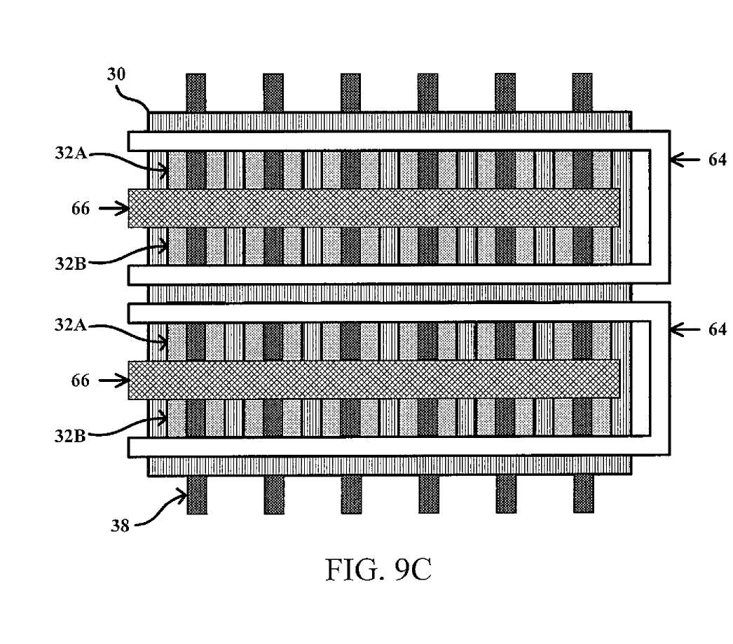

Referring to FIG. 9A, FIG. 9A shows the shadow mask of another preferred embodiment according to the invention. In this embodiment, each of the lighting cells of the plasma display panel is divided into a first sub-cell 32A and a second sub-cell 32B. When a target lighting cell among the lighting cells is assigned to be lightened, both the first sub-cell 32A and the second sub-cell 32B of the target lighting cell are operated to be lightened. Dividing a lighting cell into two sub-cells can increase the spread area of the color phosphors and can improve the utilization efficiency of ultraviolet rays.

As shown in FIG. 9B, all the first sub-cells 32A and the second sub-cells 32B in the same row of the lighting cells can share a scan electrode 64 and an auxiliary electrode 66, and the scan electrode 64 is located between the first sub-cell 32A and the second sub-cell 32B, FIG. 9C shows another configuration of the scan electrode 64 and the auxiliary electrode 66 making the auxiliary electrode 66 be located between the first sub-cell 32A and the second sub-cell 32B.

According to the invention, the first sub-cells 32A and the second sub-cells 32B can also have their own scan electrodes respectively. That is to say, if a plasma display panel includes N rows and M columns of lighting cells 32, the front plate must include 2*N scan electrodes 34 and N auxiliary electrodes 36, and the back plate includes M address electrodes 38.

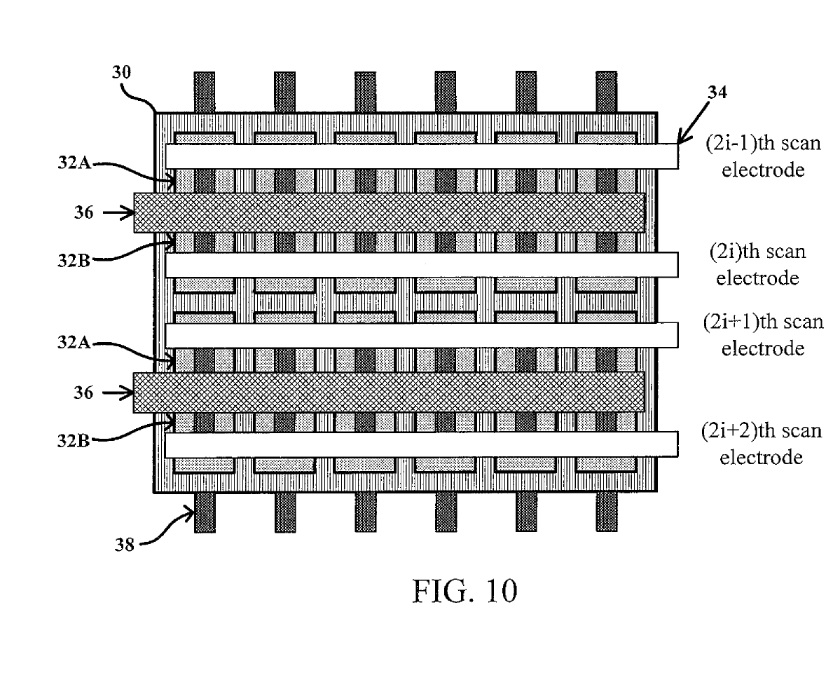

Referring to FIG. 10, FIG. 10 is a schematic diagram of the plasma display panel including 2*N scan electrodes 34. The first sub-cells 32A in the ith row of lighting cells 32 among the N rows of lighting cells 32 correspond to the (2i−1)th scan electrode 34 among the 2*N scan electrodes 34 and the ith auxiliary electrode 36 among the N auxiliary electrodes 36. The second sub-cells 32B in the ith row of lighting cells 32 among the N rows of lighting cells 32 correspond to the (2i)th scan electrode 34 among the 2*N scan electrodes 34 and the ith auxiliary electrode 36 among the N auxiliary electrodes 36. It is the same as the former embodiment that the jth lighting cell 32 in the ith row of lighting cells 32 corresponds to the jth address electrode 38 in the M address electrodes 38.

When the jth lighting cell 32 in the ith row of lighting cells 32 is assigned to be lightened, the (2i−1)th scan electrode 34, the (2i)th scan electrode 34, the ith auxiliary electrode 36, and the jth address electrode 38 are operated to generate discharge effects in the first sub-cell 32A and second sub-cell 32B of the jth lighting cell in the ith row of lighting cells 32.

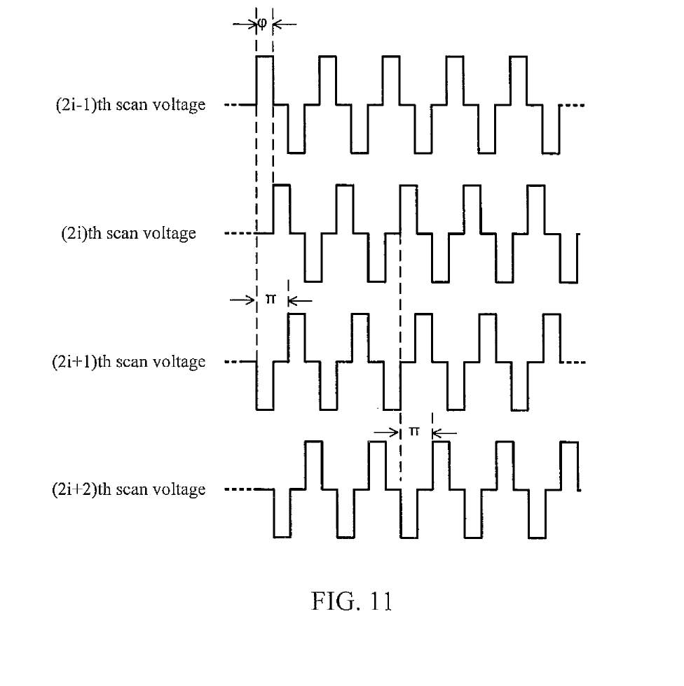

The advantage of making the first sub-cells 32A and the second sub-cells 32B have their own scan electrodes 34 respectively is that the designer can adjust the scan voltages with more flexibility. FIG. 11 shows an example of the scan voltage corresponding to two adjacent rows of lighting cells during a sustain period.

In the example of FIG. 11, during a first sustain period for lightening the jth lighting cell in the ith row of lighting cells, a (2i−1)th scan voltage is applied to the (2i−1)th scan electrode, and a (2i)th scan voltage is applied to the (2i)th scan electrode. The (2i−1)th scan voltage includes a first AC voltage; the (2i)th scan voltage includes a second AC voltage. As shown in FIG. 11, the second AC voltage is lag in phase compared with the first AC voltage. The phase lag is smaller than π and is represented by ψ.

During a second sustain period for lightening the jth lighting cell in the (i+1)th row of lighting cells, a (2i+1)th scan voltage is applied to the (2i+1)th scan electrode among the 2*N scan electrodes, and a (2i+2)th scan voltage is applied to the (2i+2)th scan electrode among the 2*N scan electrodes. The (2i+1)th scan voltage includes a third AC voltage; the (2i+2)th scan voltage includes a fourth AC voltage. As shown in FIG. 11, the first AC voltage and the third AC voltage are substantially out of phase, and the second AC voltage and the fourth AC voltage are substantially out of phase.

The current peak of the entire circuit can be lowered by dispersing the times at which each of the scan voltages reaches the voltage peak; thus, the load of the circuit system can be reduced.

On the other hand, the ith auxiliary voltage and the jth address voltage are DC voltages. In practical applications, if each of the auxiliary voltages is designed to have the same value, the N auxiliary electrodes can be connected with each other.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A plasma display panel (PDP), comprising:
N rows and M columns of lighting cells, wherein N and M are positive integers;
a front plate comprising N scan electrodes and N auxiliary electrodes, the ith row of lighting cells among the N rows of lighting cells being corresponding to the ith scan electrode among the N scan electrodes and the ith auxiliary electrode among the N auxiliary electrodes, wherein i is an integer index ranging from 1 to N; and
a back plate comprising M address electrodes, the jth lighting cell in the ith row of lighting cells being corresponding to the jth address electrode among the M address electrodes, wherein j is an integer index ranging from 1 to M;
wherein when the jth lighting cell in the ith row of lighting cells is assigned to be lightened, the ith scan electrode, the ith auxiliary electrode, and the jth address electrode are operated to generate discharge effects in said jth lighting cell in the ith row of lighting cells.

2. The PDP of claim 1, wherein during a first sustain period for lightening the jth lighting cell in the ith row of lighting cells, an ith scan voltage is applied to the ith scan electrode, an ith auxiliary voltage is applied to the ith auxiliary electrode, a jth address voltage is applied to the jth address electrode, the ith scan voltage comprises a first AC voltage, and the ith auxiliary voltage and the jth address voltage are substantially DC voltages.

3. The PDP of claim 2, wherein during a second sustain period for lightening the jth lighting cell in the (i+1)th row of lighting cells, an (i+1)th scan voltage is applied to the (i+1)th scan electrode among the N scan electrodes, the (i+1)th scan voltage comprises a second AC voltage, the amplitudes of the first AC voltage and the second AC voltage are substantially the same, and the first AC voltage and the second AC voltage are substantially out of phase.

4. The PDP of claim 1, wherein each of the lighting cells in the ith row of lighting cells comprises a first lighting region and a second lighting region, the distances between the ith scan electrode and the ith auxiliary electrode, corresponding to the first lighting regions, are larger than those corresponding to the second lighting regions.

5. The PDP of claim 1, wherein the N auxiliary electrodes are connected with each other.

6. The PDP of claim 1, wherein the lighting cells are a plurality of spaces separated by a shadow mask located between the front plate and the back plate.

7. The PDP of claim 1, wherein the shadow mask comprises a plurality of barrier ribs and a plurality of color phosphors.

8. The PDP of claim 1, wherein the front plate further comprises a first glass substrate, a transparent dielectric layer, and a first protective layer.

9. The PDP of claim 1, wherein the back plate further comprises a second glass substrate, a dielectric layer, and a second protective layer.

10. The PDP of claim 1, wherein each of the lighting cells comprises a first sub-cell and a second sub-cell, when a target lighting cell among the lighting cells is assigned to be lightened, both the first sub-cell and the second sub-cell of the target lighting cell are lightened.

11. A plasma display panel (PDP), comprising:
N rows and M columns of lighting cells, each of the lighting cells comprising a first sub-cell and a second sub-cell, wherein N and M are positive integers;
a front plate comprising 2*N scan electrodes and N auxiliary electrodes, the first sub-cells in the ith row of lighting cells among the N rows of lighting cells being corresponding to the (2i−1)th scan electrode among the 2*N scan electrodes and the ith auxiliary electrode among the N auxiliary electrodes, the second sub-cells in the ith row of lighting cells among the N rows of lighting cells being corresponding to the (2i)th scan electrode among the 2*N scan electrodes and the ith auxiliary electrode among the N auxiliary electrodes, wherein i is an integer index ranging from 1 to N; and
a back plate comprising M address electrodes, the jth lighting cell in the ith row of lighting cells being corresponding to the jth address electrode among the M address electrodes, wherein j is an integer index ranging from 1 to M;
wherein when the jth lighting cell in the ith row of lighting cells is assigned to be lightened, the (2i−1)th scan electrode, the (2i)th scan electrode, the ith auxiliary electrode, and the jth address electrode are operated to generate discharge effects in the first sub-cell and the second sub-cell of said jth lighting cell in the ith row of lighting cells; and
wherein during a first sustain period for lightening the jth lighting cell in the ith row of lighting cells, an (2i−1)th scan voltage is applied to the (2i−1)th scan electrode, an (2i)th scan voltage is applied to the (2i)th scan electrode, the (2i−1)th scan voltage comprises a first AC voltage, the (2i)th scan voltage comprises a second AC voltage, and the second AC voltage is lag in phase compared with the first AC voltage.

12. The PDP of claim 11, wherein during a second sustain period for lightening the jth lighting cell in the (i+1)th row of lighting cells, an (2i+1)th scan voltage is applied to the (2i+1)th scan electrode among the 2*N scan electrodes, an (2i+2)th scan voltage is applied to the (2i+2)th scan electrode among the 2*N scan electrodes, the (2i+1)th scan voltage comprises a third AC voltage, the (2i+2)th scan voltage comprises a fourth AC voltage, the first AC voltage and the third AC voltage are substantially out of phase, and the second AC voltage and the fourth AC voltage are substantially out of phase.

13. The PDP of claim 11, wherein a phase lag between the first AC voltage and the second AC voltage is smaller than π.

14. The PDP of claim 11, wherein the N auxiliary electrodes are connected with each other.
